(19) United States
(12) Patent Application Publication
(10) Pub. No.: US 2026/0270842 A1
(43) Pub. Date: Sep. 10, 2026

(54) MULTI-PATH PROCESSING METHOD AND APPARATUS AND COMMUNICATION SYSTEM

(71) Applicant: 1FINITY Inc., Kawasaki-shi (JP)

(72) Inventors: Guorong LI, Beijing (CN); Su YI, Beijing (CN); Meiyi JIA, Beijing (CN); Xin WANG, Beijing (CN)

(73) Assignee: 1FINITY Inc., Kawasaki-shi (JP)

(21) Appl. No.: 19/663,338

(22) Filed: Apr. 30, 2026

Related U.S. Application Data
(63) Continuation of application No. PCT/CN2023/129314, filed on Nov. 2, 2023.

(51) Int. Cl. H04W 40/22; H04W 28/02

(52) U.S. Cl. CPC H04W 40/22; H04W 28/0278

(57) ABSTRACT

A multi-path processing method and apparatus and a communication system. The method includes: communicating with a network device by using a direct path and an indirect path; and triggering or transmitting a BSR of a Uu BSR corresponding to the direct path and an SL-BSR corresponding to the indirect path, or, triggering or transmitting an SR of a first SR associated with a Uu BSR corresponding to the direct path and a second SR associated with an SL-BSR corresponding to the indirect path, or triggering or transmitting the first SR and the second SR, the first SR and the second SR using identical SR configurations.

### CROSS-REFERENCE TO RELATED APPLICATION

This application is a continuation application under 35 U.S.C. 111 (a) of International Patent Application PCT/CN2023/129314 filed on Nov. 2, 2023, and designated the U.S., the entire contents of which are incorporated herein by reference.

### FIELD

This disclosure relates to the field of communication technologies.

### BACKGROUND

In Release 18 of the 3rd Generation Partnership Project (3GPP), supporting multi-path schemes are studied, so as to enhance reliability and throughput of communications. A scenario of the multi-path may be: a remote user equipment (UE) is connected to the same network device (e.g. a gNB) by using a direct path and an indirect path, wherein the direct path may be that the remote terminal equipment is connected directly to the network device via a Uu interface, and the indirect path may be that the remote user equipment is connected to the network device via a UE-to-network relay of layer 2 (L2), such as being connected to the network device via a relay UE.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

It was found by the inventors that for a multi-path bearer, a primary radio link control (RLC) entity and a secondary RLC entity may be associated with a single media access control (MAC) entity. As a Uu interface logical channel (Uu LCH) and a sidelink logical channel (SL LCH) are usually configured in different logical channel groups (LCGs), when the multi-path bearer has data arrived, both a Uu interface buffer status report (BSR) and a sidelink buffer status report (SL-BSR) may possibly be triggered.

As the Uu interface BSR (Uu BSR) and the SL-BSR are transmitted via a direct path, such as being both possibly transmitted via a primary cell (PCell), more radio resources in the direct path will be consumed.

In order to solve at least one of the above problems, embodiments of this disclosure provide a multi-path processing method and apparatus and a communication system.

According to one aspect of the embodiments of this disclosure, there is provided a multi-path processing apparatus, configured in a remote terminal equipment, the apparatus including: a first communication unit configured to communicate with a network device by using a direct path and an indirect path; and a first processing unit configured to trigger or transmit a buffer status report (BSR) of a Uu interface buffer status report (Uu BSR) corresponding to the direct path and a sidelink buffer status reports (SL-BSR) corresponding to the indirect path.

According to another aspect of the embodiments of this disclosure, there is provided a multi-path processing apparatus, configured in a remote terminal equipment, the apparatus including: a second communication unit configured to communicate with a network device by using a direct path and an indirect path; and a second processing unit configured to trigger or transmit a scheduling request (SR) of a first SR associated with a Uu BSR corresponding to the direct path and a second SR associated with an SL-BSR corresponding to the indirect path, or trigger or transmit the first SR and the second SR, the first SR and the second SR using identical SR configurations.

According to a further aspect of the embodiments of this disclosure, there is provided a multi-path processing apparatus, configured in a remote terminal equipment, the apparatus including: a third communication unit configured to communicate with a network device by using a direct path and an indirect path, wherein a PDCP entity is associated with a first RLC entity corresponding to the direct path and an SRAP entity corresponding to the indirect path; and a third processing unit configured to indicate a PDCP data volume, the PDCP data volume being used to trigger a BSR.

According to still another aspect of the embodiments of this disclosure, there is provided a multi-path processing apparatus, configured in a network device, the apparatus including: a fourth communication unit configured to communicate with a remote terminal equipment by using a direct path and an indirect path; and a first receiving unit configured to receive a buffer status report (BSR) of a Uu interface buffer status report (Uu BSR) corresponding to the direct path and a sidelink buffer status reports (SL-BSR) corresponding to the indirect path.

According to yet another aspect of the embodiments of this disclosure, there is provided a multi-path processing apparatus, configured in a network device, the apparatus including: a fifth communication unit configured to communicate with a network device by using a direct path and an indirect path; and a second receiving unit configured to receive a scheduling request (SR) of a first SR associated with a Uu BSR corresponding to the direct path and a second SR associated with an SL-BSR corresponding to the indirect path, or receive the first SR and the second SR, the first SR and the second SR using identical SR configurations.

According to yet further aspect of the embodiments of this disclosure, there is provided a multi-path processing method, applicable to a remote terminal equipment, the method including: communicating with a network device by using a direct path and an indirect path; and triggering or transmitting a buffer status report (BSR) of a Uu interface buffer status report (Uu BSR) corresponding to the direct path and a sidelink buffer status reports (SL-BSR) corresponding to the indirect path.

According to yet further another aspect of the embodiments of this disclosure, there is provided a multi-path processing method, applicable to a remote terminal equipment, the method including: communicating with a network device by using a direct path and an indirect path; and triggering or transmitting a scheduling request (SR) of a first SR associated with a Uu BSR corresponding to the direct path and a second SR associated with an SL-BSR corresponding to the indirect path, or triggering or transmitting the first SR and the second SR, the first SR and the second SR using identical SR configurations.

According to yet further still another aspect of the embodiments of this disclosure, there is provided a multi-path processing method, applicable to a remote terminal equipment, the method including: communicating with a network device by using a direct path and an indirect path, wherein a PDCP entity is associated with a first RLC entity corresponding to the direct path and an SRAP entity corresponding to the indirect path; and indicating a PDCP data volume, the PDCP data volume being used to trigger a BSR.

According to even another aspect of the embodiments of this disclosure, there is provided a multi-path processing method, applicable to a network device, the method including: communicating with a remote terminal equipment by using a direct path and an indirect path; and receiving a buffer status report (BSR) of a Uu interface buffer status report (Uu BSR) corresponding to the direct path and a sidelink buffer status reports (SL-BSR) corresponding to the indirect path.

According to even further another aspect of the embodiments of this disclosure, there is provided a multi-path processing method, applicable to a network device, the method including: communicating with a network device by using a direct path and an indirect path; and receiving a scheduling request (SR) of a first SR associated with a Uu BSR corresponding to the direct path and a second SR associated with an SL-BSR corresponding to the indirect path, or receiving the first SR and the second SR, the first SR and the second SR using identical SR configurations.

According to even further still another aspect of the embodiments of this disclosure, there is provided a remote terminal equipment, including a memory and a processor, the memory storing a computer program, and the processor being configured to execute the computer program to carry out the multi-path processing methods at the remote terminal equipment side described above.

According to yet still another aspect of the embodiments of this disclosure, there is provided a network device, including a memory and a processor, the memory storing a computer program, and the processor being configured to execute the computer program to carry out the multi-path processing methods at the network device side described above.

According to yet further still another aspect of the embodiments of this disclosure, there is provided a communication system, including the above-described remote terminal equipment and network device.

One of the advantages of the embodiments of this disclosure exists in that radio resource consumption may be reduced, power consumption of the UE may be saved, and uplink radio resources may be saved.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of an embodiment of this disclosure;

FIG. 2 is a schematic diagram of a multi-path scenario of an embodiment of this disclosure;

FIG. 3 is a schematic diagram of a multi-path bearer of an embodiment of this disclosure;

FIG. 4 is a schematic diagram of a data volume in a protocol entity in the multi-path bearer of the embodiment of this disclosure;

FIGS. 5-9 are schematic diagrams of multi-path processing methods of embodiments of this disclosure;

FIGS. 10-14 are schematic diagrams of multi-path processing apparatuses of embodiments of this disclosure;

FIG. 15 is a schematic diagram of a structure of a remote terminal equipment of an embodiment of this disclosure; and

FIG. 16 is a schematic diagram of a structure of a network device of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, a machine to machine (M2M) terminal, and a terminal supporting sidelink communication, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to a terminal equipment.

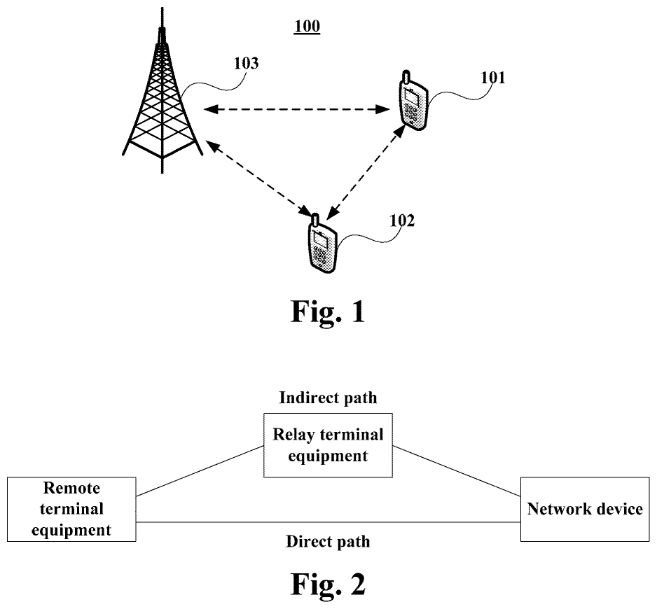

FIG. 1 is a schematic diagram of a communication system of an embodiment of this disclosure, illustrating a case taking a remote terminal equipment, a relay terminal equipment and a network device as an example. As shown in FIG. 1, the communication system 100 may include a remote terminal equipment 101, a relay terminal equipment 102 and a network device 103. The remote terminal equipment 101 is connected to the network device 103 via a direct path and an indirect path passing through the relay terminal equipment 102. For the sake of simplicity, description is given in FIG. 1 by taking two terminal equipments (one remote terminal equipment and one relay terminal equipment) and one network device as an example; however, the embodiment of this disclosure is not limited thereto.

In the embodiment of this disclosure, existing services or services that may be implemented in the future may be performed between the network device 103 and the remote terminal equipment 101 and the relay terminal equipment 102. For example, such services may include but not limited to an enhanced mobile broadband (eMBB), massive machine type communication (MTC), ultra-reliable and low-latency communication (URLLC), etc.

FIG. 2 is a schematic diagram of a multi-path scenario of the embodiment of this disclosure. As shown in FIG. 2, in the embodiment of this disclosure, the remote terminal equipment may simultaneously communicate with the network device (such as a gNB) via a direct path and an indirect path. For example, the remote terminal equipment may communicate with a network device via a Uu interface (the direct path) and communicate with the same network device via the relay terminal equipment (the indirect path).

For example, the direct path between the remote terminal equipment and the network device uses a Uu interface protocol stack, the indirect path between the remote terminal equipment and the network device is transmitted via the relay terminal equipment, a sidelink between the remote terminal equipment and the relay terminal equipment uses a PC5 interface protocol stack, and a Uu interface protocol stack is used between the relay terminal equipment and the network device.

In some embodiments, a multi-path transmission bearer may use a duplication transmission mode or a split transmission mode. Concepts of currently-defined primary path and primary RLC entity are adopted for a bearer of the split transmission (split bearer) and a bearer of the duplication transmission (duplication bearer). For the duplication bearer, a PDCP controls PDUs to be transmitted only on the primary RLC entity.

For a data radio bearer of the split transmission (referred to as split data radio bearer (DRB)), an uplink data split transmission threshold may be optionally configured. When a sum of PDCP layer data volume (PDCP data volume), Uu interface RLC data volume (Uu RLC data volume) and sidelink RLC data volume (SL-RLC data volume) exceeds the threshold, the PDCP may transmit data via the direct path and the indirect path.

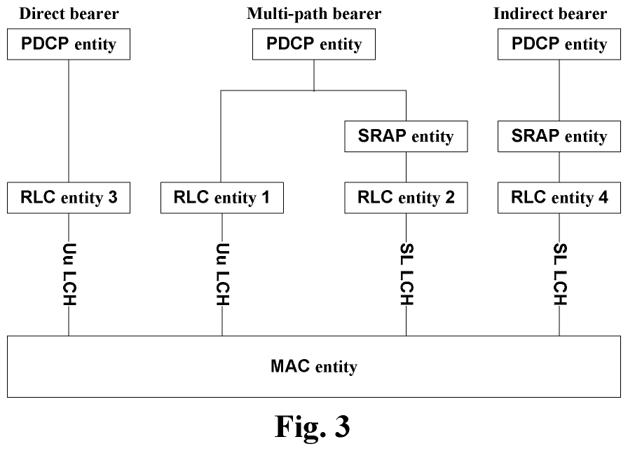

FIG. 3 is a schematic diagram of the multi-path bearer of the embodiment of this disclosure. As shown in FIG. 3, in multi-path, a type of the bearer may include a bearer that transmits only via a direct path (referred to as a direct path bearer, direct bearer), a bearer that transmits only via an indirect path (referred to as an indirect path bearer, indirect bearer), and a bearer that transmits via a direct path and an indirect path, i.e. a multi-path transmission bearer (referred to as a multi-path bearer).

A PDCP entity corresponding to the direct bearer is associated with one or more Uu RLC entities (RLC entity 3 in FIG. 3), a PDCP entity corresponding to the indirect bearer is associated with one or more SRAP entities, the one or more SRAP entities being associated with one or more SL-RLC entities (RLC entity 4 in FIG. 3), a PDCP entity corresponding to the multi-path bearer is associated with a Uu RLC entity (RLC entity 1 in FIG. 3) and an SRAP entity of the indirect path, the SRAP entity being associated with an SL-RLC entity (RLC entity 2 in FIG. 3).

In some embodiments, as shown in FIG. 3, the multi-path may be supported by a single MAC entity.

In some embodiments, as shown in FIG. 3, for the direct path bearer, a buffer size in the Uu BSR may be used to indicate data of a logical channel (Uu LCH) group with which the Uu BSR is associated, the logical channel group including at least one logical channel.

In some embodiments, as shown in FIG. 3, for the indirect path bearer, a buffer size in the SL-BSR may be used to indicate data of a sidelink logical channel (LCH) group with which the SL-BSR is associated, the logical channel group including at least one sidelink logical channel.

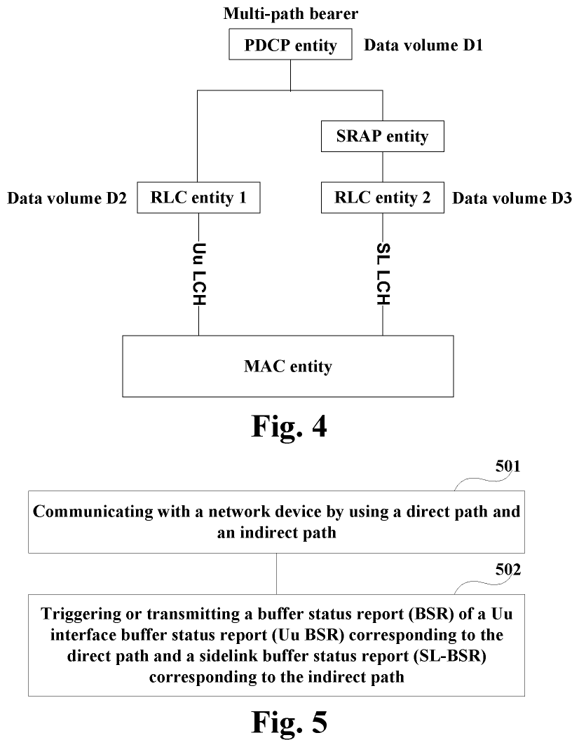

FIG. 4 is a schematic diagram of a data volume in a protocol entity in the multi-path bearer of the embodiment of this disclosure. In some embodiments, as shown in FIG. 4, for the multi-path bearer, the buffer size in the Uu BSR may be used to indicate a sum of a data volume in PDCP entities corresponding to all logical channels in the logical channel group and a data volume in the Uu RLC entity (RLC entity 1), and the buffer size in the SL-BSR may be used to indicate a sum of a data volume in PDCP entities corresponding to all logical channels in the logical channel group and a data volume in the SL-RLC entity (RLC entity 2).

For example, the sum of the data volume D1 in the PDCP entity and the data volume D2 in the Uu RLC entity (RLC entity 1) may be calculated in the buffer size of the Uu BSR, and the sum of the data volume D1 in the PDCP entity and the data volume D3 in the SL-RLC entity (RLC entity 2) may be calculated in the buffer size of the SL-BSR.

Implementations of the embodiments of this disclosure shall be described below with reference to the accompanying drawings. These implementations are illustrative only, and are not intended to limit this disclosure.

### Embodiment of a First Aspect

The embodiment of this disclosure provides a multi-path processing method, applicable to a remote terminal equipment. FIG. 5 is a schematic diagram of the multi-path processing method of the embodiment of this disclosure. As shown in FIG. 5, the method includes:

501: communicating with a network device by using a direct path and an indirect path; and

502: triggering or transmitting a buffer status report (BSR) of a Uu interface buffer status report (Uu BSR) corresponding to the direct path and a sidelink buffer status report (SL-BSR) corresponding to the indirect path.

According to the above embodiment, in a multi-path scenario, the remote terminal equipment triggers or transmits one of the buffer status reports of the Uu interface and the sidelink buffer status report, thereby may reduce resource consumption for reporting a buffer status report, so as to lower power consumption of the remote terminal equipment and save uplink radio resources.

For example, in a case where the buffer status report of the Uu interface and the sidelink buffer status report need to be reported through an identical path or cell, resource consumption can be reduced, and resource utilization can be improved.

In some embodiments, the remote terminal equipment may communicate with the same network device via a direct path and an indirect path, i.e. the remote terminal equipment is connected to the same network device by using a direct path and an indirect path.

The remote terminal equipment may be connected to a first cell of the network device, and the relay terminal equipment may be connected to a second cell of the network device, the first cell and the second cell being identical or different cells.

In some embodiments, the Uu BSR corresponding to the direct path may also be expressed as a BSR, or an uplink BSR, or a UL-BSR, and is used to report buffer status information to an uplink logical channel group (LCG), such as a data volume of to be transmitted data in the uplink logical channel group, etc.

The SL-BSR corresponding to the indirect path is used to report buffer status information corresponding to a sidelink logical channel group, such as a data volume of to be transmitted data in the sidelink logical channel group, etc.

In some embodiments, in a case where the logical channel of the Uu interface (Uu LCH) and the sidelink logical channel (SL LCH) are configured in different logical channel groups (LCGs) and the multi-path bearer has data arrived, the remote terminal equipment may only trigger one of a Uu BSR and an SL-BSR.

In some embodiments, the triggered BSR may be a BSR corresponding to a primary path or a BSR associated with a primary radio link control (RLC) entity.

For example, in a case where a primary path is a direct path, the triggered BSR may be a Uu BSR, and in a case where a primary path is an indirect path, the triggered BSR may be an SL-BSR.

For another example, in a case where a BSR associated with a primary RLC entity is a Uu BSR, the triggered BSR may be a Uu BSR, and in a case where a BSR associated with a primary RLC entity is an SL-BSR, the triggered BSR may be an SL-BSR.

In some embodiments, at the remote terminal equipment side, the MAC entity determines whether to trigger the BSR. A specific mode for the MAC entity to determine whether to trigger the BSR may be described in a form of Table 1.

TABLE 1
Example of triggering the BSR by the MAC entity

A BSR shall be triggered if any of the following events occur for activated cell group:

| | |
|---|---|
| - | UL data, for a logical channel which belongs to an LCG, becomes available to the MAC entity; and |
| | for multi-path, the logical channel is associated with the primary RLC entity; and either |

| | |
|---|---|
| - | this UL data belongs to a logical channel with higher priority than the priority of any logical |
| | channel containing available UL data which belong to any LCG; or |
| - | none of the logical channels which belong to an LCG contains any available UL data. |

| | |
|---|---|
| | in which case the BSR is referred below to as ‘Regular BSR’; |
| - | UL resources are allocated and number of padding bits is equal to or larger than the size of the |
| | Buffer Status Report MAC CE plus its subheader, in which case the BSR is referred below to as |
| | ‘Padding BSR’; |
| - | retxBSR-Timer expires, and at least one of the logical channels which belong to an LCG contains |
| | UL data, and for multi-path, the logical channel is associated with the primary RLC entity, in which |
| | case the BSR is referred below to as ‘Regular BSR’; |

| | |
|---|---|
| - | periodicBSR-Timer expires, in which case the BSR is referred below to as ‘Periodic BSR’. |

In some embodiments, the triggered BSR may be a Uu BSR, that is, the triggered BSR may be the Uu BSR associated with the uplink RLC entity.

For example, a specific mode for the MAC entity to determine whether to trigger the BSR may be described in a form of Table 2.

TABLE 2
Example of triggering the BSR by the MAC entity

A BSR shall be triggered if any of the following events occur for activated cell group:

| | |
|---|---|
| - | UL data, for a logical channel which belongs to an LCG, becomes available to the MAC entity; and |
| | for multi-path, the logical channel is associated with the UL RLC entity; and either |

| | |
|---|---|
| - | this UL data belongs to a logical channel with higher priority than the priority of any logical |
| | channel containing available UL data which belong to any LCG; or |
| - | none of the logical channels which belong to an LCG contains any available UL data. |

| | |
|---|---|
| | in which case the BSR is referred below to as ‘Regular BSR’; |
| - | UL resources are allocated and number of padding bits is equal to or larger than the size of the |
| | Buffer Status Report MAC CE plus its subheader, in which case the BSR is referred below to as |
| | ‘Padding BSR’; |
| - | retxBSR-Timer expires, and at least one of the logical channels which belong to an LCG contains |
| | UL data, and for multi-path, the logical channel is associated with the UL RLC entity, in which |
| | case the BSR is referred below to as ‘Regular BSR’; |

| | |
|---|---|
| - | periodicBSR-Timer expires, in which case the BSR is referred below to as ‘Periodic BSR’. |

In some embodiments, the triggered BSR may be an SL-BSR, that is, the triggered BSR may be the SL-BSR associated with the sidelink RLC entity.

For example, a specific mode for the MAC entity to determine whether to trigger the BSR may be described in a form of Table 3.

TABLE 3
Example of triggering the BSR by the MAC entity

A BSR shall be triggered if any of the following events occur for activated cell group:

| | |
|---|---|
| - | UL data, for a logical channel which belongs to an LCG, becomes available to the MAC entity; and |
| | for multi-path, the logical channel is associated with the sidelink RLC entity; and either |

| | |
|---|---|
| - | this UL data belongs to a logical channel with higher priority than the priority of any logical |
| | channel containing available UL data which belong to any LCG; or |
| - | none of the logical channels which belong to an LCG contains any available UL data. |

| | |
|---|---|
| | in which case the BSR is referred below to as ‘Regular BSR’; |
| - | UL resources are allocated and number of padding bits is equal to or larger than the size of the |
| | Buffer Status Report MAC CE plus its subheader, in which case the BSR is referred below to as |
| | ‘Padding BSR’; |
| - | retxBSR-Timer expires, and at least one of the logical channels which belong to an LCG contains |
| | UL data, and for multi-path, the logical channel is associated with the sidelink RLC entity, in which |
| | case the BSR is referred below to as ‘Regular BSR’; |

| | |
|---|---|
| - | periodicBSR-Timer expires, in which case the BSR is referred below to as ‘Periodic BSR’. |

In some embodiments, the triggered BSR may be a BSR determined based on indication information or configuration information of the network device. In other words, the triggered BSR may be indicated or configured by the network device.

The indication information or configuration information of the network device may be included in an RRC message or a MAC CE, for example, the indication information or configuration information indicates BSRs used by all multi-path bearers configured for the UE, or indicates BSRs respectively used by multi-path bearers configured for the UE.

In some embodiments, the triggered BSR may be a BSR determined based on priorities of the Uu BSR and the SL-BSR in resource allocation in current logical channel prioritization (LCP). For example, whichever of the Uu BSR and the SL-BSR having a higher priority is triggered.

In some embodiments, in case where the Uu interface logical channel (Uu LCH) and the sidelink logical channel (SL LCH) are configured in different logical channel groups (LCGs) and the multi-path bearer has data arrived, the remote terminal equipment may trigger the Uu BSR and the SL-BSR and transmit one of the triggered Uu BSR and SL-BSR, that is, both the Uu BSR and the SL-BSR will be triggered, but only one of them will be transmitted.

In some embodiments, one of a buffer status report media access control element of the Uu interface (Uu BSR MAC CE) and a sidelink buffer status report media access control element (SL-BSR MAC CE) is generated.

For example, a specific mode for the MAC entity to generate the BSR MAC CE may be described in a form of Table 4.

TABLE 4
Example of generating the BSR MAC CE by the MAC entity

The MAC entity shall:

| | |
|---|---|
| 1> | if the Buffer Status reporting procedure determines that at least one BSR has been triggered and not |
| | cancelled: |

| | |
|---|---|
| 2> | if UL-SCH resources are available for a new transmission and the UL-SCH resources can |
| | accommodate the BSR MAC CE plus its subheader as a result of logical channel prioritization: |

| | |
|---|---|
| 3> | instruct the Multiplexing and Assembly procedure to generate one of the BSR MAC CE(s) |
| | and SL-BSR MAC CE as defined in clause 6.1.3.1; |
| 3> | start or restart periodicBSR-Timer except when all the generated BSRs are long or short |
| | Truncated or Extended long or short Truncated BSRs; |

| | |
|---|---|
| 3> | start or restart retxBSR-Timer. |

In some embodiments, the remote terminal equipment may generate one of the Uu BSR MAC CE and the SL-BSR MAC CE in a manner as follows that:
one of the Uu BSR MAC CE and the SL-BSR MAC CE is generated based on the priorities of the Uu BSR and the SL-BSR in the resource allocation in the current logical channel prioritization, such as generating a MAC CE of the Uu BSR and the SL-BSR whichever having a higher priority; or
the Uu BSR MAC CE is generated prior to the SL-BSR MAC CE; or
the SL-BSR MAC CE is generated prior to the Uu BSR MAC CE; or
a media access control control element (MAC CE) of the BSR corresponding to the primary path is generated or the BSR MAC CE corresponding to the secondary path is not generated; for example, if the direct path is configured as a primary path, the Uu BSR MAC CE is generated, or the SL-BSR MAC CE is not generated; or
one of the Uu BSR MAC CE and the SL-BSR MAC CE is generated based on the configuration information or indication information of the network device; for example, the configuration information or indication information of the network device may be included in an RRC message or a MAC CE, and the configuration information or indication information may indicate which BSR MAC CE is generated by the UE in the above situation, or indicate which BSR MAC CE is generated in the above situation respectively to each multi-path bearer configured for the UE; or
one of Uu BSR MAC CE and the SL-BSR MAC CE is generated based on predefined information.

In some embodiments, a media access control protocol data unit (MAC PDU) includes one of the Uu BSR MAC CE and the SL-BSR MAC CE.

For example, the MAC PDU may be described in a form of Table 5.

TABLE 5
Example of the MAC PDU

A MAC PDU shall contain at most one of BSR MAC CE and SL-BSR
MAC CE, even when multiple events have triggered a BSR. The Regular
BSR and the Periodic BSR shall have precedence over the padding BSR.

In some embodiments, the remote terminal equipment may include one of the Uu BSR MAC CE and the SL-BSR MAC CE in the MAC PDU in a manner as follows that:
one of the Uu BSR MAC CE and the SL-BSR MAC CE is included in the MAC PDU based on the priorities of the Uu BSR and the SL-BSR in the resource allocation in the current logical channel prioritization; for example, one of the Uu BSR MAC CE and the SL-BSR MAC CE is included in the MAC PDU whichever having a higher priority; or
the Uu BSR MAC CE is included in the MAC PDU prior to the SL-BSR MAC CE; or
the SL-BSR MAC CE is included in the MAC PDU prior to the Uu BSR MAC CE; or
the MAC CE of the BSR corresponding to the primary path is included in the MAC PDU or the MAC CE of the BSR corresponding to the secondary path is not included in the MAC PDU; for example, if the direct path is configured as a primary path, the Uu BSR MAC CE is included in the MAC PDU, or, the SL-BSR MAC CE is not included in the MAC PDU; or
one of the Uu BSR MAC CE and the SL-BSR MAC CE is included in the MAC PDU based on the configuration information or indication information of the network device; for example, the indication information or configuration information of the network device may be included in an RRC message or a MAC CE, and the configuration information or indication information may indicate which BSR MAC CE is included in the MAC PDU in the above situation to the UE, or indicate which BSR MAC CE is included in the MAC PDU in the above situation respectively to each multi-path bearer configured for the UE; or
one of the Uu BSR MAC CE and the SL-BSR MAC CE is included in the MAC PDU based predefined information.

In some embodiments, one of the triggered Uu BSR and SL-BSR is canceled.

For example, the canceling the triggered Uu BSR or SL-BSR may be described in a form of Table 6.

TABLE 6
Examples of canceling the triggered Uu BSR or SL-BSR

The triggered BSRs may be cancelled when at least one SL-BSR is
triggered.

In some embodiments, one of the triggered Uu BSR and SL-BSR may be cancelled in a manner as following that:
one of the Uu BSR and the SL-BSR is cancelled based on the priorities of the Uu BSR and the SL-BSR in the resource allocation in the current logical channel prioritization; for example, one of the Uu BSR and the SL-BSR whichever having a lower priority is cancelled; or
the Uu BSR is cancelled prior to the SL-BSR; or
the SL-BSR is cancelled prior to the Uu BSR; or
the BSR corresponding to the primary path is not cancelled or a BSR corresponding to a secondary path is cancelled; for example, if the direct path is configured as a primary path, the Uu BSR is not cancelled, or, the SL-BSR is cancelled; or
one of the Uu BSR and the SL-BSR is cancelled based on the configuration information or indication information of the network device; for example, the indication information or configuration information of the network device may be included in an RRC message or a MAC CE, and the configuration information or indication information may indicate which BSR is canceled in the above situation by the UE, or indicate which BSR is canceled in the above situation respectively to each multi-path bearer configured for the UE; or
one of the Uu BSR and the SL-BSR is cancelled based on predefined information.

It should be noted that FIG. 5 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 5.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that in a multi-path scenario, the remote terminal equipment triggers or transmits one of the buffer status reports of the Uu interface and the sidelink buffer status report, thereby reducing resource consumption in reporting the buffer status report, saving power consumption of the remote terminal equipment, and saving uplink radio resources. For example, in a case where the buffer status report of the Uu interface and the sidelink buffer status report need to be reported in identical paths or cells, resource consumption may be reduced, and resource utilization may be improved.

### Embodiment of a Second Aspect

The embodiment of this disclosure provides a multi-path processing method, applicable to a remote terminal equipment side, with contents identical to those in the embodiment of the first aspect being not going to be described herein any further. The embodiment of the second aspect may be implemented separately, or, the embodiment of the second aspect may be implemented in combination with the embodiment of the first aspect.

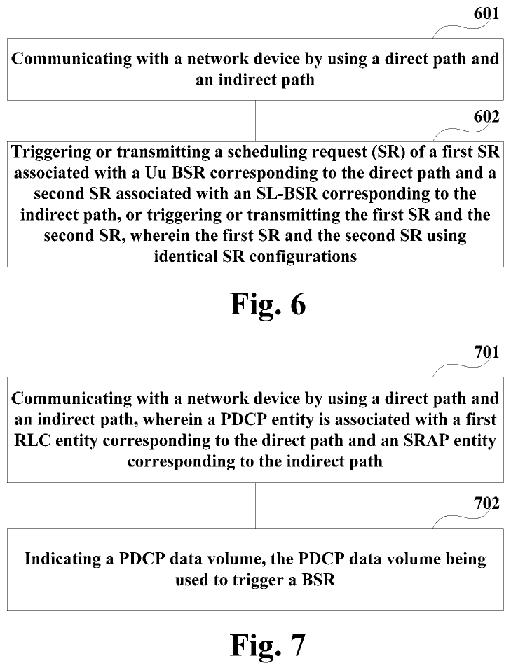

FIG. 6 is a schematic diagram of the multi-path processing method of the embodiment of this disclosure. As shown in FIG. 6, the method includes:

601: communicating with a network device by using a direct path and an indirect path; and

602: triggering or transmitting a scheduling request (SR) of a first SR associated with a Uu BSR corresponding to the direct path and a second SR associated with an SL-BSR corresponding to the indirect path, or triggering or transmitting the first SR and the second SR, wherein the first SR and the second SR using identical SR configurations.

In some embodiments, for a multi-path bearer, if both the Uu BSR and the SL-BSR are triggered or may be transmitted (e.g. the Uu BSR and the SL-BSR are triggered or transmitted according to their respective conditions), in a case where there are no uplink resources available for new transmission (such as there are no uplink resources available for transmitting the Uu BSR and the SL-BSR) or uplink resources available for new transmission are unable to accommodate a Uu BSR MAC CE plus its subheaders or an SL-BSR plus its subheaders, the Uu BSR and the SL-BSR will respectively trigger associated SRs, thereby increasing consumption of uplink resources.

According to the above embodiment, in a multi-path scenario, the remote terminal equipment triggers or transmits one of the first SR associated with the Uu BSR and the second SR associated with the SL-BSR, or triggers or transmits the first SR and the second SR by using identical SR configurations, thereby avoiding unnecessary SR reporting, reducing resource consumption in reporting the SR, saving power consumption of the remote terminal equipment, and saving uplink radio resources.

In some embodiments, the remote terminal equipment may trigger or transmit one of the first SR and the second SR in a manner as follows that:
a scheduling request associated with one of the Uu BSR and the SL-BSR is triggered or transmitted based on priorities of the Uu BSR and the SL-BSR in resource allocation in current logical channel prioritization; for example, a scheduling request associated with a BSR with higher priority in the Uu BSR and the SL-BSR is triggered or transmitted; or
the first SR associated with the Uu BSR is triggered or transmitted prior to the second SR associated with the SL-BSR; or
the second SR associated with the SL-BSR is triggered or transmitted prior to the first SR associated with the Uu BSR; or
the SR associated with the BSR corresponding to the primary path is triggered or transmitted or the SR associated with the BSR corresponding to the secondary path is not triggered or transmitted; for example, if the direct path is configured as a primary path, the SR associated with the Uu BSR corresponding to the direct path is triggered or transmitted, or the SR associated with the SL-BSR corresponding to the indirect path is not triggered or transmitted; or
a scheduling request associated with one of the Uu BSR and the SL-BSR is triggered or transmitted based on configuration information or indication information of the network device; for example, the configuration information or indication information of the network device may be included in an RRC message or a MAC CE, and the configuration information or indication information may indicate which SR is triggered or transmitted in the above situation by the UE, or indicate which SR is triggered or transmitted in the above situation respectively to each multi-path bearer configured for the UE; or
an SR associated with one of the Uu BSR and the SL-BS is triggered or transmitted based on predefined information.

In some embodiments, when both the first SR and the second SR are to be triggered or transmitted, the first SR and the second SR use identical SR configurations. The terminal equipment may determine an order in which the first SR and the second SR are transmitted in a manner as follows that:
in a case of triggering or transmitting the first scheduling request and the second scheduling request, an order in which the first scheduling request and the second scheduling request are transmitted is determined in a manner as follows that:
the order in which the first SR and the second SR are transmitted is determined based on the priorities of the Uu BSR and the SL-BSR in the resource allocation in the current logical channel prioritization; for example, an SR associated with the Uu BSR and the SL-BSR whichever having a higher priority is transmitted first; or
the first SR associated with the Uu BSR is transmitted prior to the second SR associated with the SL-BSR; or
the second SR associated with the SL-BSR is transmitted prior to the first SR associated with the Uu BSR; or
the SR associated with the BSR corresponding to the primary path is transmitted first or the SR associated with the BSR corresponding to the secondary path is transmitted later; for example, if the direct path is configured as a primary path, an SR associated with the Uu BSR corresponding to the direct path is transmitted first or an SR associated with the SL-BSR corresponding to the indirect path is transmitted later; or
the order in which the first SR and the second SR are transmitted is determined based on the configuration information or indication information of the network device; for example, the configuration information or indication information of the network device may be included in an RRC message or a MAC CE, and the configuration information or indication information may indicate which SR is transmitted first or later in the above situation by the UE, or indicate which SR is transmitted first or later in the above situation respectively to each multi-path bearer configured for the UE; or
the order in which the first SR and the second SR are transmitted is determined based on predefined information, that is, an SR associated with one of the Uu BSR and the SL-BS is transmitted first.

In some embodiments, the SR configurations include a set of physical uplink control channel (PUCCH) resources configured for SRs in different bandwidth parts (BWPs) and cells; however, this disclosure is not limited thereto, and the SR configurations may also include other contents.

It should be noted that FIG. 6 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 6.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that in a multi-path scenario, the remote terminal equipment triggers or transmits one of the first SR associated with the Uu interface and the second SR associated with the SL-BSR, or triggers or transmits the first SR and the second SR by using identical SR configurations, thereby avoiding unnecessary SR reporting, reducing resource consumption in reporting the SR, saving power consumption of the remote terminal equipment, and saving uplink radio resources.

### Embodiment of a Third Aspect

The embodiment of this disclosure provides a multi-path processing method, applicable to a remote terminal equipment side, with contents identical to those in the embodiments of the first aspect and the second aspect being not going to be described herein any further. The embodiment of the third aspect may be implemented separately, or, the embodiment of the third aspect may be implemented in combination with the embodiment(s) of the first aspect and/or the second aspect.

FIG. 7 is a schematic diagram of the multi-path processing method of the embodiment of this disclosure. As shown in FIG. 7, the method includes:

701: communicating with a network device by using a direct path and an indirect path, wherein a PDCP entity is associated with a first RLC entity corresponding to the direct path and an SRAP entity corresponding to the indirect path; and

702: indicating a PDCP data volume, wherein the PDCP data volume being used to trigger a BSR.

In some embodiments, in 701, as shown in FIGS. 3 and 4, for a multi-path bearer, a PDCP entity is associated with a first RLC entity (RLC entity 1) corresponding to the direct path and an SRAP entity corresponding to the indirect path, and an SRAP entity corresponds to a second RLC entity (RLC entity 2).

In some embodiments, one of the first RLC entity and the second RLC entity is configured as a primary RLC entity. For example, the direct path is a primary path, the first RLC entity is configured as a primary RLC entity, and the indirect path is the primary path, the second RLC entity is configured as a primary RLC entity.

In some embodiments, the first RLC entity and the SRAP entity correspond to one MAC entity; however, this disclosure is not limited thereto, and the first RLC entity and the SRAP entity may also correspond to different MAC entities.

In some embodiments, in 702, the PDCP entity may indicate a data volume to the MAC entity, hence, the MAC entity may trigger the BSR according to the data volume, or calculate a buffer size (BS). Reference may be made to the contents described in the embodiment of the first aspect for a mode for the MAC entity to trigger or transmit the BSR.

In some embodiments, the PDCP entity may indicate a data volume to a MAC entity in a manner as follows. For example, in a case where PDCP duplication is activated, a PDCP data volume is indicated to the MAC entity associated with the primary RLC entity, and/or a PDCP data volume excluding a PDCP control PDU is indicated to a MAC entity associated with an RLC entity other than the primary RLC entity and for which PDCP duplication is activated, and/or a PDCP data volume is indicated to be 0 to a MAC entity associated with the RLC entity for which PDCP duplication is deactivated.

In some embodiments, the PDCP entity may also indicate a data volume to a MAC entity in a manner as follows. For example, in a case where a split secondary RLC entity is configured and a total amount of a PDCP data volume and an RLC data volume to be transmitted in the primary path and the secondary path is greater than or equal to a preset threshold, the PDCP data volume is indicated to a MAC entity associated with the primary RLC entity and the split secondary RLC entity, and/or the PDCP data volume is indicated to be 0 to a MAC entity associated with an RLC entity other than the primary RLC entity and the split secondary RLC entity.

In some embodiments, the PDCP entity may also indicate a data volume to a MAC entity in a manner as follows. For example, in a case where no split secondary RLC entity is configured, the PDCP data volume is indicated to the MAC entity associated with the primary RLC entity, and/or the PDCP data volume is indicated to be 0 to a MAC entity associated with an RLC entity other than the primary RLC entity.

For example, a specific mode for the PDCP entity to indicate the data volume may be described in a form of Table 7.

TABLE 7
Example of indicating the data volume by the PDCP entity

| | |
|---|---|
| ∘ | If the transmitting PDCP entity is associated with a Uu RLC entity and a SRAP entity of a SL |
| | indirect path, when indicating the PDCP data volume to a MAC entity for BSR triggering and |
| | Buffer Size calculation (as specified in TS 38.321 [4] and TS 36.321 [12]), the transmitting |
| | PDCP entity shall: |

| | |
|---|---|
| ∘ | if the PDCP duplication is activated for the RB: |

| | |
|---|---|
| ∘ | indicate the PDCP data volume to the MAC entity associated with the primary |
| | RLC entity; |
| ∘ | indicate the PDCP data volume excluding the PDCP Control PDU to the MAC |
| | entity associated with the RLC entity other than the primary RLC entity and for |
| | which PDCP duplication is activated; |
| ∘ | indicate the PDCP data volume as 0 to the MAC entity associated with RLC |
| | entity for which PDCP duplication is deactivated; |

| | |
|---|---|
| ∘ | else: |

| | |
|---|---|
| ∘ | if the split secondary RLC entity is configured; and |
| ∘ | if the total amount of PDCP data volume and RLC data volume pending for |
| | initial transmission (as specified in TS 38.322 [5]) in the primary path and the |
| | secondary path is equal to or larger than ul-DataSplitThreshold: |

| | |
|---|---|
| • | indicate the PDCP data volume [symbol] the MAC entity associated with |
| | the primary RLC entity and [symbol] associated with the split |
| | secondary RLC entity; |
| • | indicate the PDCP data volume as 0 to the MAC entity associated with |
| | RLC entity other than the primary RLC entity and the split secondary |
| | RLC entity; |

| | |
|---|---|
| ∘ | else: |

| | |
|---|---|
| • | indicate the PDCP data volume to the MAC entity associated with the |
| | primary RLC entity; |
| • | indicate the PDCP data volume as 0 to the MAC entity associated with |
| | the RLC entity other than the primary RLC entity. |

In some embodiments, the split secondary RLC entity may be an RLC entity other than the primary RLC entity. For example, the split secondary RLC entity may be described in a form of Table 8.

TABLE 8
Example of the split secondary RLC entity

| | |
|---|---|
| ∘ | Split secondary RLC entity: in dual connectivity or multi-path, the RLC entity other than the |
| | primary RLC entity which is responsible for split bearer operation. If the PDCP entity is associated |
| | with two RLC entities, the split secondary RLC entity is the RLC entity other than the primary RLC |
| | entity. If the PDCP entity is associated with more than two RLC entities, the split secondary RLC |
| | entity is configured by upper layers. If the PDCP entity is associated with a Uu RLC entity and a |
| | SRAP entity of a SL indirect path, the split secondary RLC entity is the RLC entity other than the |
| | primary RLC entity. |

It should be noted that FIG. 7 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 7.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that in a case where the remote terminal equipment communicates with the network device by using the direct path and the indirect path, a PDCP entity is associated with the first RLC entity corresponding to the direct path and an SRAP entity corresponding to the indirect path, and the PDCP entity indicates the PDCP data volume to the MAC entity. Thus, the MAC entity is able to trigger the BSR reasonably according to the data volume, which is helpful to reasonably allocating uplink radio resources.

### Embodiment of a Fourth Aspect

The embodiment of this disclosure provides a multi-path processing method, applicable to a network device side, with contents identical to those in the embodiments of the first to the third aspects being not going to be described herein any further.

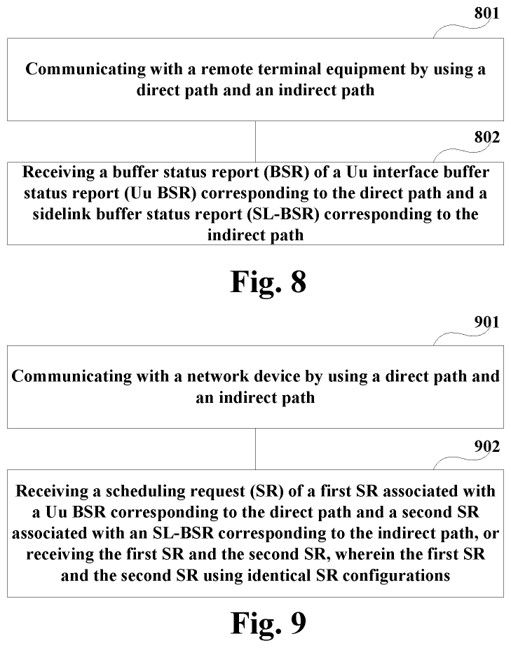

FIG. 8 is a schematic diagram of the multi-path processing method of the embodiment of this disclosure. As shown in FIG. 8, the method includes:

801: communicating with a remote terminal equipment by using a direct path and an indirect path; and

802: receiving a buffer status report (BSR) of a Uu interface buffer status report (Uu BSR) corresponding to the direct path and a sidelink buffer status report (SL-BSR) corresponding to the indirect path.

In some embodiments, the received BSR is a BSR corresponding to a primary path or a BSR associated with a primary radio link control (RLC) entity.

In some embodiments, the received BSR is the Uu BSR.

In some embodiments, the received BSR is the SL-BSR.

In some embodiments, the received BSR is a BSR determined based on indication information or configuration information of the network device.

In some embodiments, the received BSR is a BSR determined based on priorities of the Uu BSR and the SL-BSR in resource allocation in current logical channel prioritization.

In some embodiments, one of a buffer status report media access control element of the Uu interface (Uu BSR MAC CE) and a sidelink buffer status report media access control element (SL-BSR MAC CE) is received.

In some embodiments, one of the Uu BSR MAC CE and the SL-BSR MAC CE is received based on the priorities of the Uu BSR and the SL-BSR in the resource allocation in the current logical channel prioritization; or
the Uu BSR MAC CE is received prior to the SL-BSR MAC CE; or
the SL-BSR MAC CE is received prior to the Uu BSR MAC CE; or
a media access control element (MAC CE) of the BSR corresponding to the primary path is received; or
one of the Uu BSR MAC CE and the SL-BSR MAC CE is received based on the configuration information or indication information of the network device; or
one of the Uu BSR MAC CE and the SL-BSR MAC CE is received based on predefined information.

In some embodiments, a media access control protocol data unit (MAC PDU) includes one of the Uu BSR MAC CE and the SL-BSR MAC CE.

In some embodiments, one of the Uu BSR MAC CE and the SL-BSR MAC CE is included in the MAC PDU based on the priorities of the Uu BSR and the SL-BSR in the resource allocation in the current logical channel prioritization; or
the Uu BSR MAC CE is included in the MAC PDU prior to the SL-BSR MAC CE; or
the SL-BSR MAC CE is included in the MAC PDU prior to the Uu BSR MAC CE; or
a MAC CE of the BSR corresponding to the primary path is included in the MAC PDU; or
one of the Uu BSR MAC CE and the SL-BSR MAC CE is included in the MAC PDU based on the configuration information or indication information of the network device; or
one of the Uu BSR MAC CE and the SL-BSR MAC CE is included in the MAC PDU based on predefined information.

It should be noted that FIG. 8 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 8.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that in a multi-path scenario, the network device receives one of the buffer status reports of the Uu interface and the sidelink buffer status report, thereby reducing resource consumption in reporting the buffer status report, saving power consumption of the remote terminal equipment, and saving uplink radio resources. For example, in a case where the buffer status report of the Uu interface and the sidelink buffer status report need to be reported in identical paths or cells, resource consumption may be reduced, and resource utilization may be improved.

### Embodiment of a Fifth Aspect

The embodiment of this disclosure provides a multi-path processing method, applicable to a network device side, with contents identical to those in the embodiments of the first to the fourth aspects being not going to be described herein any further.

FIG. 9 is a schematic diagram of the multi-path processing method of the embodiment of this disclosure. As shown in FIG. 9, the method includes:

901: communicating with a network device by using a direct path and an indirect path; and

902: receiving a scheduling request (SR) of a first SR associated with a Uu BSR corresponding to the direct path and a second SR associated with an SL-BSR corresponding to the indirect path, or receiving the first SR and the second SR, wherein the first SR and the second SR using identical SR configurations.

In some embodiments, an SR associated with one of the Uu BSR and the SL-BS is received based on priorities of the Uu BSR and the SL-BSR in resource allocation in current logical channel prioritization; or
the first SR associated with the Uu BSR is received prior to the second SR associated with the SL-BSR; or
the second SR associated with the SL-BSR is received prior to the first SR associated with the Uu BSR; or
an SR associated with a BSR corresponding to the primary path is received; or
an SR associated with one of the Uu BSR and the SL-BS is received based on configuration information or indication information of the network device; or
an SR associated with one of the Uu BSR and the SL-BS is received based on predefined information.

In some embodiments, the SR configurations include a set of physical uplink control channel (PUCCH) resources for configuring SRs in different bandwidth parts (BWPs) and cells.

It should be noted that FIG. 9 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 9.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that in a multi-path scenario, the network device receives one of the first SR associated with the Uu BSR and the second SR associated with the SL-BSR, or receives the first SR and the second SR using identical SR configurations, thereby reducing resource consumption in reporting the buffer status report, saving power consumption of the remote terminal equipment, and saving uplink radio resources.

### Embodiment of a Sixth Aspect

The embodiment of this disclosure provides a multi-path processing apparatus. The apparatus may be, for example, a remote terminal equipment, or may be one or some components or assemblies configured in the remote terminal equipment, with contents identical to those in the embodiment of the first aspect being not going to be described herein any further.

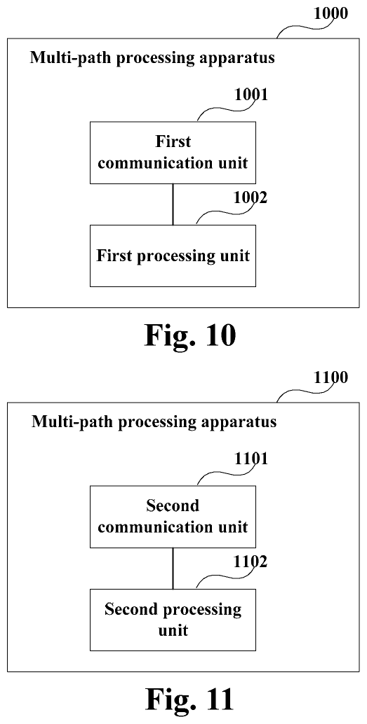

FIG. 10 is a schematic diagram of the multi-path processing apparatus of the embodiment of this disclosure. As shown in FIG. 10, the multi-path processing apparatus 1000 includes:
a first communication unit 1001 configured to communicate with a network device by using a direct path and an indirect path; and
a first processing unit 1002 configured to trigger or transmit a buffer status report (BSR) of a Uu interface buffer status report (Uu BSR) corresponding to the direct path and a sidelink buffer status reports (SL-BSR) corresponding to the indirect path.

In some embodiments, the triggered BSR is a BSR corresponding to a primary path or a BSR associated with a primary radio link control (RLC) entity.

In some embodiments, the triggered BSR is the Uu BSR.

In some embodiments, the triggered BSR is the SL-BSR.

In some embodiments, the triggered BSR is a BSR determined according to indication information or configuration information of the network device.

In some embodiments, the triggered BSR is a BSR determined according to priorities of the Uu BSR and the SL-BSR in resource allocation in current logical channel prioritization.

In some embodiments, the Uu BSR and the SL-BSR are triggered, and one of the Uu BSR and the SL-BSR is transmitted.

In some embodiments, one of a Uu interface buffer status report media access control control element (Uu BSR MAC CE) and a sidelink buffer status report media access control control element (SL-BSR MAC CE) is generated.

In some embodiments, one of the Uu BSR MAC CE and the SL-BSR MAC CE is generated based on the priorities of the Uu BSR and the SL-BSR in the resource allocation in the current logical channel prioritization; or
the Uu BSR MAC CE is generated prior to the SL-BSR MAC CE; or
the SL-BSR MAC CE is generated prior to the Uu BSR MAC CE; or
a media access control control element of the BSR corresponding to the primary path is generated; or
one of the Uu BSR MAC CE and the SL-BSR MAC CE is generated based on the configuration information or indication information of the network device; or
one of Uu BSR MAC CE and the SL-BSR MAC CE is generated based on predefined information.

In some embodiments, a media access control protocol data unit (MAC PDU) includes one of the Uu BSR MAC CE and the SL-BSR MAC CE.

In some embodiments, one of the Uu BSR MAC CE and the SL-BSR MAC CE is included in the MAC PDU based on the priorities of the Uu BSR and the SL-BSR in the resource allocation in the current logical channel prioritization; or
the Uu BSR MAC CE is included in the MAC PDU prior to the SL-BSR MAC CE; or
the SL-BSR MAC CE is included in the MAC PDU prior to the Uu BSR MAC CE; or
the MAC CE of the BSR corresponding to the primary path is included in the MAC PDU; or
one of the Uu BSR MAC CE and the SL-BSR MAC CE is included in the MAC PDU based on the configuration information or indication information of the network device; or
one of the Uu BSR MAC CE and the SL-BSR MAC CE is included in the MAC PDU based predefined information.

In some embodiments, one of the triggered Uu BSR and SL-BSR is cancelled.

In some embodiments, one of the Uu BSR and the SL-BSR is cancelled based on the priorities of the Uu BSR and the SL-BSR in the resource allocation in the current logical channel prioritization; or
the Uu BSR is cancelled prior to the SL-BSR; or
the SL-BSR is cancelled prior to the Uu BSR; or
the BSR corresponding to the primary path is not cancelled or a BSR corresponding to a secondary path is cancelled; or
one of the Uu BSR and the SL-BSR is cancelled based on the configuration information or indication information of the network device; or
one of the Uu BSR and the SL-BSR is cancelled based on predefined information.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path processing apparatus 1000 may further include other components or modules, and reference may be made to related techniques for particulars of these components or modules.

Furthermore, for the sake of simplicity, connection relationships between the components or modules or signal profiles thereof are only illustrated in FIG. 10. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that in a multi-path scenario, the remote terminal equipment triggers or transmits one of the buffer status reports of the Uu interface and the sidelink buffer status report, thereby reducing resource consumption in reporting the buffer status report, saving power consumption of the remote terminal equipment, and saving uplink radio resources. For example, in a case where the buffer status report of the Uu interface and the sidelink buffer status report need to be reported in identical paths or cells, resource consumption may be reduced, and resource utilization may be improved.

### Embodiment of a Seventh Aspect

The embodiment of this disclosure provides a multi-path processing apparatus. The apparatus may be, for example, a remote terminal equipment, or may be one or some components or assemblies configured in the remote terminal equipment, with contents identical to those in the embodiment of the second aspect being not going to be described herein any further.

FIG. 11 is a schematic diagram of the multi-path processing apparatus of the embodiment of this disclosure. As shown in FIG. 11, the multi-path processing apparatus 1100 includes:
a second communication unit 1101 configured to communicate with a network device by using a direct path and an indirect path; and
a second processing unit 1102 configured to trigger or transmit a scheduling request (SR) of a first SR associated with a Uu BSR corresponding to the direct path and a second SR associated with an SL-BSR corresponding to the indirect path, or triggering or transmitting the first SR and the second SR, wherein the first SR and the second SR using identical SR configurations.

In some embodiments, an SR associated with one of the Uu BSR and the SL-BS is triggered or transmitted based on priorities of the Uu BSR and the SL-BSR in resource allocation in current logical channel prioritization; or
the first SR associated with the Uu BSR is triggered or transmitted prior to the second SR associated with the SL-BSR; or
the second SR associated with the SL-BSR is triggered or transmitted prior to the first SR associated with the Uu BSR; or
the SR associated with the BSR corresponding to the primary path is triggered or transmitted; or
an SR associated with one of the Uu BSR and the SL-BS is triggered or transmitted based on configuration information or indication information of the network device; or
an SR associated with one of the Uu BSR and the SL-BS is triggered or transmitted based on predefined information.

In some embodiments, when both the first SR and the second SR are to be triggered or transmitted, the first SR and the second SR use identical SR configurations. The terminal equipment may determine an order in which the first SR and the second SR are transmitted in a manner as follows that:
in a case of triggering or transmitting the first scheduling request and the second scheduling request, an order in which the first scheduling request and the second scheduling request are transmitted is determined in a manner as follows that:
the order in which the first SR and the second SR are transmitted is determined based on the priorities of the Uu BSR and the SL-BSR in the resource allocation in the current logical channel prioritization; for example, an SR associated with the Uu BSR and the SL-BSR whichever having a higher priority is transmitted first; or
the first SR associated with the Uu BSR is transmitted prior to the second SR associated with the SL-BSR; or
the second SR associated with the SL-BSR is transmitted prior to the first SR associated with the Uu BSR; or
the SR associated with the BSR corresponding to the primary path corresponds is transmitted first or the SR associated with the BSR corresponding to the secondary path is transmitted later; for example, if the direct path is configured as a primary path, an SR associated with the Uu BSR corresponding to the direct path is transmitted first or an SR associated with the SL-BSR corresponding to the indirect path is transmitted later; or
the order in which the first SR and the second SR are transmitted is determined based on the configuration information or indication information of the network device; for example, the configuration information or indication information of the network device may be included in an RRC message or a MAC CE, and the configuration information or indication information may indicate which SR is transmitted first or later in the above situation by the UE, or indicate which SR is transmitted first or later in the above situation respectively to each multi-path bearer configured for the UE; or
the order in which the first SR and the second SR are transmitted is determined based on predefined information, that is, an SR associated with one of the Uu BSR and the SL-BS is transmitted first.

In some embodiments, the SR configurations include a set of physical uplink control channel (PUCCH) resources configured for scheduling requests in different bandwidth parts (BWPs) and cells.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path processing apparatus 1100 may further include other components or modules, and reference may be made to related techniques for particulars of these components or modules.

Furthermore, for the sake of simplicity, connection relationships between the components or modules or signal profiles thereof are only illustrated in FIG. 11. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that in a multi-path scenario, the remote terminal equipment triggers or transmits one of the first SR associated with the Uu interface and the second SR associated with the SL-BSR, or triggers or transmits the first SR and the second SR by using identical SR configurations, thereby avoiding unnecessary SR reporting, reducing resource consumption in reporting the SR, saving power consumption of the remote terminal equipment, and saving uplink radio resources.

### Embodiment of an Eighth Aspect

The embodiment of this disclosure provides a multi-path processing apparatus. The apparatus may be, for example, a remote terminal equipment, or may be one or some components or assemblies configured in the remote terminal equipment, with contents identical to those in the embodiment of the third aspect being not going to be described herein any further.

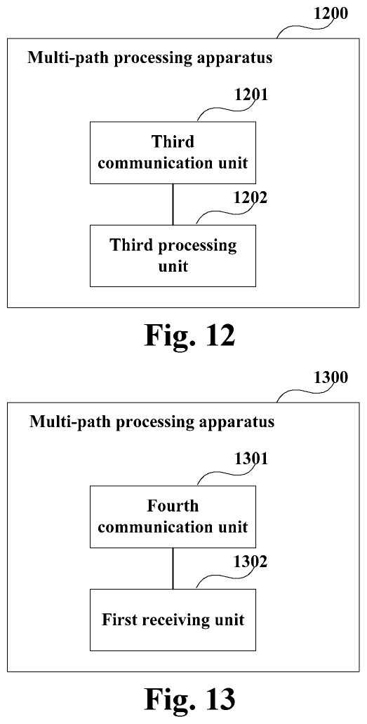

FIG. 12 is a schematic diagram of the multi-path processing apparatus of the embodiment of this disclosure. As shown in FIG. 12, the multi-path processing apparatus 1200 includes:
a third communication unit 1201 configured to communicate with a network device by using a direct path and an indirect path, wherein a PDCP entity is associated with a first RLC entity corresponding to the direct path and an SRAP entity corresponding to the indirect path; and
a third processing unit 1202 configured to indicate a PDCP data volume, wherein the PDCP data volume being used to trigger a BSR.

In some embodiments, the SRAP entity corresponds to a second RLC entity.

In some embodiments, one of the first RLC entity and the second RLC entity is configured as a primary RLC entity.

In some embodiments, the first RLC entity and the SRAP entity correspond to one MAC entity.

In some embodiments, in a case where PDCP duplication is activated,
a PDCP data volume is indicated to the MAC entity associated with the primary RLC entity, and/or
a PDCP data volume excluding a PDCP control PDU is indicated to a MAC entity associated with an RLC entity other than the primary RLC entity and for which PDCP duplication is activated, and/or
a PDCP data volume is indicated to be 0 to a MAC entity associated with the RLC entity for which PDCP duplication is deactivated.

In some embodiments, in a case where a split secondary RLC entity is configured and a total amount of a PDCP data volume and an RLC data volume to be transmitted in the primary path and the secondary path is greater than or equal to a preset threshold,
the PDCP data volume is indicated to a MAC entity associated with the primary RLC entity and the split secondary RLC entity, and/or
the PDCP data volume is indicated to be 0 to a MAC entity associated with an RLC entity other than the primary RLC entity and the split secondary RLC entity.

In some embodiments, in a case where no split secondary RLC entity is configured, the PDCP data volume is indicated to the MAC entity associated with the primary RLC entity, and/or
the PDCP data volume is indicated to be 0 to a MAC entity associated with an RLC entity other than the primary RLC entity.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path processing apparatus 1200 may further include other components or modules, and reference may be made to related techniques for particulars of these components or modules.

Furthermore, for the sake of simplicity, connection relationships between the components or modules or signal profiles thereof are only illustrated in FIG. 12. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the above embodiment, in a case where the remote terminal equipment communicates with the network device by using the direct path and the indirect path, a PDCP entity is associated with the first RLC entity corresponding to the direct path and an SRAP entity corresponding to the indirect path, and the PDCP entity indicates the PDCP data volume to the MAC entity. Thus, the MAC entity is able to trigger the BSR reasonably according to the data volume, which is helpful to reasonably allocating uplink radio resources.

### Embodiment of a Ninth Aspect

The embodiment of this disclosure provides a multi-path processing apparatus. The apparatus may be, for example, a network device, or may be one or some components or assemblies configured in the network device, with contents identical to those in the embodiment of the fourth aspect being not going to be described herein any further.

FIG. 13 is a schematic diagram of the multi-path processing apparatus of the embodiment of this disclosure. As shown in FIG. 13, the multi-path processing apparatus 1300 includes:
a fourth communication unit 1301 configured to communicate with a remote terminal equipment by using a direct path and an indirect path; and
a first receiving unit 1302 configured to receive a buffer status report (BSR) of a Uu interface buffer status report (Uu BSR) corresponding to the direct path and a sidelink buffer status report (SL-BSR) corresponding to the indirect path.

In some embodiments, the received BSR is a BSR corresponding to a primary path or a BSR associated with a primary radio link control (RLC) entity.

In some embodiments, the received BSR is the Uu BSR.

In some embodiments, the received BSR is the SL-BSR.

In some embodiments, the received BSR is a BSR determined based on indication information or configuration information of the network device.

In some embodiments, the received BSR is a BSR determined based on priorities of the Uu BSR and the SL-BSR in resource allocation in current logical channel prioritization.

In some embodiments, one of a buffer status report media access control element of the Uu interface (Uu BSR MAC CE) and a sidelink buffer status report media access control element (SL-BSR MAC CE) is received.

In some embodiments, one of the Uu BSR MAC CE and the SL-BSR MAC CE is received based on the priorities of the Uu BSR and the SL-BSR in the resource allocation in the current logical channel prioritization; or
the Uu BSR MAC CE is received prior to the SL-BSR MAC CE; or
the SL-BSR MAC CE is received prior to the Uu BSR MAC CE; or
a media access control element (MAC CE) of the BSR corresponding to the primary path is received; or
one of the Uu BSR MAC CE and the SL-BSR MAC CE is received based on the configuration information or indication information of the network device; or
one of the Uu BSR MAC CE and the SL-BSR MAC CE is received based on predefined information.

In some embodiments, a media access control protocol data unit (MAC PDU) includes one of the Uu BSR MAC CE and the SL-BSR MAC CE.

In some embodiments, one of the Uu BSR MAC CE and the SL-BSR MAC CE is included in the MAC PDU based on the priorities of the Uu BSR and the SL-BSR in the resource allocation in the current logical channel prioritization; or
the Uu BSR MAC CE is included in the MAC PDU prior to the SL-BSR MAC CE; or
the SL-BSR MAC CE is included in the MAC PDU prior to the Uu BSR MAC CE; or
a MAC CE of the BSR corresponding to the primary path is included in the MAC PDU; or
one of the Uu BSR MAC CE and the SL-BSR MAC CE is included in the MAC PDU based on the configuration information or indication information of the network device; or
one of the Uu BSR MAC CE and the SL-BSR MAC CE is included in the MAC PDU based on predefined information.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path processing apparatus 1300 may further include other components or modules, and reference may be made to related techniques for particulars of these components or modules.

Furthermore, for the sake of simplicity, connection relationships between the components or modules or signal profiles thereof are only illustrated in FIG. 13. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the above embodiment, in a multi-path scenario, the network device receives one of the buffer status reports of the Uu interface and the sidelink buffer status report, thereby reducing resource consumption in reporting the buffer status report, saving power consumption of the remote terminal equipment, and saving uplink radio resources. For example, in a case where the buffer status report of the Uu interface and the sidelink buffer status report need to be reported in identical paths or cells, resource consumption may be reduced, and resource utilization may be improved.

### Embodiment of a Tenth Aspect

The embodiment of this disclosure provides a multi-path processing apparatus. The apparatus may be, for example, a network device, or may be one or some components or assemblies configured in the network device, with contents identical to those in the embodiment of the fifth aspect being not going to be described herein any further.

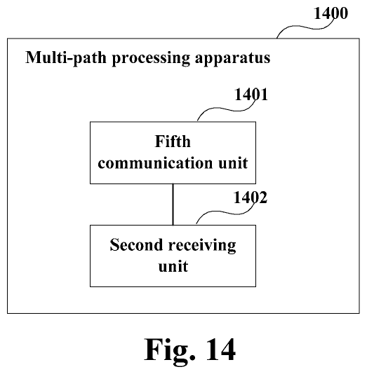

FIG. 14 is a schematic diagram of the multi-path processing apparatus of the embodiment of this disclosure. As shown in FIG. 14, the multi-path processing apparatus 1400 includes:
a fifth communication unit 1401 configured to communicate with a network device by using a direct path and an indirect path; and
a second receiving unit 1402 configured to receive a scheduling request (SR) of a first SR associated with a Uu BSR corresponding to the direct path and a second SR associated with an SL-BSR corresponding to the indirect path, or receiving the first SR and the second SR, the first SR and the second SR using identical SR configurations.

In some embodiments, an SR associated with one of the Uu BSR and the SL-BS is received based on priorities of the Uu BSR and the SL-BSR in resource allocation in current logical channel prioritization; or
the first SR associated with the Uu BSR is received prior to the second SR associated with the SL-BSR; or
the second SR associated with the SL-BSR is received prior to the first SR associated with the Uu BSR; or
an SR associated with a BSR corresponding to the primary path is received; or
an SR associated with one of the Uu BSR and the SL-BS is received based on configuration information or indication information of the network device; or
an SR associated with one of the Uu BSR and the SL-BS is received based on predefined information.

In some embodiments, the SR configurations include a set of physical uplink control channel (PUCCH) resources for configuring SRs in different bandwidth parts (BWPs) and cells.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path processing apparatus 1400 may further include other components or modules, and reference may be made to related techniques for particulars of these components or modules.

Furthermore, for the sake of simplicity, connection relationships between the components or modules or signal profiles thereof are only illustrated in FIG. 14. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the above embodiment, in a multi-path scenario, the network device receives one of the first SR associated with the Uu BSR and the second SR associated with the SL-BSR, or receives the first SR and the second SR using identical SR configurations, thereby reducing resource consumption in reporting the buffer status report, saving power consumption of the remote terminal equipment, and saving uplink radio resources.

### Embodiment of an Eleventh Aspect

The embodiment of this disclosure provides a communication system, and reference may be made to FIG. 1, with contents identical to those in the embodiments of the first to the tenth aspects being not going to be described herein any further.

In some embodiments, the communication system 100 may include: a remote terminal equipment 101 and/or a relay terminal equipment 102 and/or a network device 103.

In the embodiment of this disclosure, the remote terminal equipment 101 may be configured to carry out the multi-path processing method in the embodiment(s) of the first aspect and/or the second aspect and/or the third aspect, the contents of which being incorporated herein, which shall not be described herein any further.

In the embodiment of this disclosure, the network device 103 may be configured to carry out the multi-path processing method in the embodiment(s) of the fourth aspect and/or the fifth aspect, the contents of which being incorporated herein, which shall not be described herein any further.

The embodiment of this disclosure further provides a remote terminal equipment.

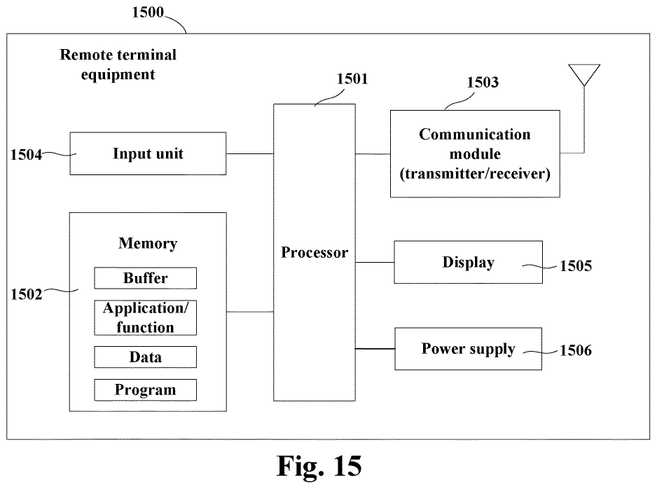

FIG. 15 is a schematic diagram of a structure of the terminal equipment of the embodiment of this disclosure. The terminal equipment may be a remote terminal equipment. As shown in FIG. 15, the terminal equipment 1500 may include a processor 1501 and a memory 1502, the memory 1502 storing data and a program and being coupled to the processor 1501. It should be noted that this figure is illustrative only, and other types of structures may also be used, so as to supplement or replace this structure and achieve a telecommunications function or other functions.

For example, the processor 1501 may be configured to execute a program to carry out the multi-path processing method in the embodiment of the first aspect. For example, the processor 1501 may be configured to executed the following operations: communicating with a network device by using a direct path and an indirect path; and triggering or transmitting a buffer status report (BSR) of a Uu interface buffer status report (Uu BSR) corresponding to the direct path and a sidelink buffer status report (SL-BSR) corresponding to the indirect path.

For another example, the processor 1501 may be configured to execute a program to carry out the multi-path processing method in the embodiment of the second aspect. For example, the processor 1501 may be configured to executed the following operations: communicating with a network device by using a direct path and an indirect path; and triggering or transmitting a scheduling request (SR) of a first SR associated with a Uu BSR corresponding to the direct path and a second SR associated with an SL-BSR corresponding to the indirect path, or triggering or transmitting the first SR and the second SR, the first SR and the second SR using identical SR configurations.

For a further example, the processor 1501 may be configured to execute a program to carry out the multi-path processing method in the embodiment of the third aspect. For example, the processor 1501 may be configured to executed the following operations: communicating with a network device by using a direct path and an indirect path, wherein a PDCP entity is associated with a first RLC entity corresponding to the direct path and an SRAP entity corresponding to the indirect path; and indicating a PDCP data volume, the PDCP data volume being used to trigger a BSR.

As shown in FIG. 15, the terminal equipment 1500 may further include a communication module 1503, an input unit 1504, a display 1505, and a power supply 1506; wherein functions of the above components are similar to those in the prior art, which shall not be described herein any further. It should be noted that the terminal equipment 1500 does not necessarily include all the parts shown in FIG. 15, and the above components are not necessary. Furthermore, the terminal equipment 1500 may include parts not shown in FIG. 15, and the prior art may be referred to.

The embodiment of this disclosure further provides a network device, which may be, for example, a base station. However, this disclosure is not limited thereto, and it may also be another network device.

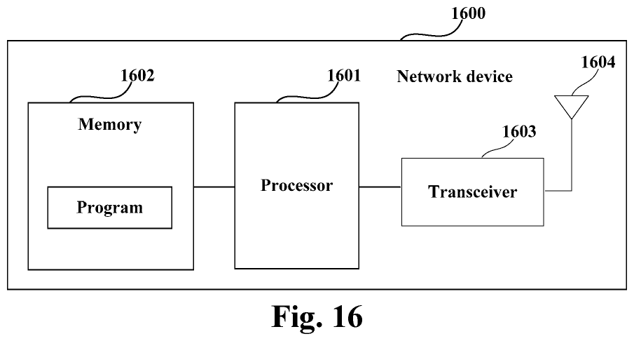

FIG. 16 is a schematic diagram of a structure of the network device of the embodiment of this disclosure. As shown in FIG. 16, the network device 1600 may include a processor 1601 (such as a central processing unit (CPU)) and a memory 1602, the memory 1602 being coupled to the processor 1601. Wherein, the memory 1602 may store various data, and furthermore, it may store a program for information processing, and execute the program under control of the processor 1601.

For example, the processor 1601 may be configured to execute a program to carry out the multi-path processing method in the embodiment of the fourth aspect. For example, the processor 1601 may be configured to executed the following operations: communicating with a remote terminal equipment by using a direct path and an indirect path; and receiving a buffer status report (BSR) of a Uu interface buffer status report (Uu BSR) corresponding to the direct path and a sidelink buffer status report (SL-BSR) corresponding to the indirect path.

For another example, the processor 1601 may be configured to execute a program to carry out the multi-path processing method in the embodiment of the fifth aspect. For example, the processor 1601 may be configured to executed the following operations: communicating with a network device by using a direct path and an indirect path; and receiving a scheduling request (SR) of a first SR associated with a Uu BSR corresponding to the direct path and a second SR associated with an SL-BSR corresponding to the indirect path, or receiving the first SR and the second SR, the first SR and the second SR using identical SR configurations.

Furthermore, as shown in FIG. 16, the network device 1600 may include a transceiver 1603, and an antenna 1605, etc. Wherein, functions of the above components are similar to those in the prior art, and shall not be described herein any further. It should be noted that the network device 1600 does not necessarily include all the parts shown in FIG. 16, and furthermore, the network device 1600 may include parts not shown in FIG. 16, and the prior art may be referred to.

An embodiment of this disclosure provides a computer readable program code, which, when executed in a remote terminal equipment, will cause a computer to carry out the multi-path processing method as described in the embodiment(s) of the first aspect and/or the second aspect and/or the third aspect in the remote terminal equipment.

An embodiment of this disclosure provides a computer readable medium, including a computer readable program code, which will cause a computer to carry out the multi-path processing method as described in the embodiment(s) of the first aspect and/or the second aspect and/or the third aspect in a remote terminal equipment.

An embodiment of this disclosure provides a computer readable program code, which, when executed in a network device, will cause a computer to carry out the multi-path processing method as described in the embodiment(s) of the fourth aspect and/or the fifth aspect in the network device.

An embodiment of this disclosure provides a computer readable medium, including a computer readable program code, which will cause a computer to carry out the multi-path processing method as described in the embodiment(s) of the fourth aspect and/or the fifth aspect in a network device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.

As to implementations containing the above embodiments, following supplements are further disclosed.
1. A multi-path processing apparatus, configured in a remote terminal equipment, the apparatus including:
a third communication unit configured to communicate with a network device by using a direct path and an indirect path, wherein a PDCP entity is associated with a first RLC entity corresponding to the direct path and an SRAP entity corresponding to the indirect path; and
a third processing unit configured to indicate a PDCP data volume, the PDCP data volume being used to trigger a BSR.
2. The apparatus according to supplement 1, wherein,
the SRAP entity corresponds to a second RLC entity.
3. The apparatus according to supplement 2, wherein,
one of the first RLC entity and the second RLC entity is configured as a primary RLC entity.
4. The apparatus according to supplement 1, wherein,
the first RLC entity and the SRAP entity correspond to one MAC entity.
5. The apparatus according to supplement 1, wherein,
in a case where PDCP duplication is activated,
a PDCP data volume is indicated to a MAC entity associated with a primary RLC entity, and/or
a PDCP data volume excluding a PDCP control PDU is indicated to a MAC entity associated with an RLC entity other than a primary RLC entity and for which PDCP duplication is activated, and/or
a PDCP data volume as 0 is indicated to a MAC entity associated with the RLC entity and for which PDCP duplication is deactivated.
6. The apparatus according to supplement 1, wherein,
in a case where a split secondary RLC entity is configured and a total amount of a PDCP data volume and an RLC data volume to be transmitted in a primary path and a secondary path is greater than or equal to a preset threshold,
the PDCP data volume is indicated to a MAC entity associated with a primary RLC entity and the split secondary RLC entity, and/or
the PDCP data volume as 0 is indicated to a MAC entity associated with an RLC entity other than a primary RLC entity and the split secondary RLC entity.
7. The apparatus according to supplement 1, wherein,
in a case where no split secondary RLC entity is configured,
the PDCP data volume is indicated to a MAC entity associated with a primary RLC entity, and/or
the PDCP data volume as 0 is indicated to a MAC entity associated with an RLC entity other than a primary RLC entity.
8. The apparatus according to supplement 6 or 7, wherein,
the split secondary RLC entity is an RLC entity other than a primary RLC entity.
9. A multi-path processing method, applicable to a remote terminal equipment, the method including:
communicating with a network device by using a direct path and an indirect path, wherein a PDCP entity is associated with a first RLC entity corresponding to the direct path and an SRAP entity corresponding to the indirect path; and
indicating a PDCP data volume, the PDCP data volume being used to trigger a BSR.
10. A communication system, including:
a remote terminal equipment configured to communicate with a network device by using a direct path and an indirect path, and trigger or transmit a buffer status report (BSR) of a Uu interface buffer status report (Uu BSR) corresponding to the direct path and a sidelink buffer status reports (SL-BSR) corresponding to the indirect path, or trigger or transmit a scheduling request (SR) of a first SR associated with a Uu BSR corresponding to the direct path and a second SR associated with an SL-BSR corresponding to the indirect path, or trigger or transmit both the first SR and the second SR, the first SR and the second SR using identical SR configurations; and
the network device configured to receive the BSR or SR.

1. A multi-path processing apparatus, configured in a remote terminal equipment, the apparatus comprising:
a third communication unit configured to communicate with a network device by using a direct path and an indirect path, wherein a Packet Data Convergence Protocol (PDCP) entity is associated with a first Radio Link Control (RLC) entity corresponding to the direct path and a Sidelink Relay Adaptation Protocol (SRAP) entity corresponding to the indirect path; and
a third processing unit configured to indicate a PDCP data volume, the PDCP data volume being used to trigger a Buffer Status Report (BSR).

2. The apparatus according to claim 1, wherein,
the SRAP entity corresponds to a second RLC entity.

3. The apparatus according to claim 2, wherein,
one of the first RLC entity and the second RLC entity is configured as a primary RLC entity.

4. The apparatus according to claim 1, wherein,
the first RLC entity and the SRAP entity correspond to one Medium Access Control (MAC) entity.

5. The apparatus according to claim 1, wherein,
in a case where PDCP duplication is activated,
a PDCP data volume is indicated to a MAC entity associated with the SRAP entity if a primary path of the direct path and the indirect path is the indirect path, and/or
a PDCP data volume excluding a PDCP control protocol data unit (PDU) is indicated to a MAC entity associated with an RLC entity other than a primary RLC entity and for which PDCP duplication is activated, and/or
a PDCP data volume as 0 is indicated to a MAC entity associated with an RLC entity for which PDCP duplication is deactivated.

6. The apparatus according to claim 1, wherein,
in a case where a split secondary RLC entity is configured and a total volume of PDCP data volume and RLC data volume to be transmitted in a primary path and a secondary path is greater than or equal to a preset threshold,
the PDCP data volume is indicated to a MAC entity associated with a primary RLC entity and the split secondary RLC entity, and/or
the PDCP data volume as 0 is indicated to a MAC entity associated with an RLC entity other than a primary RLC entity and the split secondary RLC entity.

7. The apparatus according to claim 1, wherein,
in a case where no split secondary RLC entity is configured,
the PDCP data volume is indicated to a MAC entity associated with a primary RLC entity, and/or
the PDCP data volume as 0 is indicated to a MAC entity associated with an RLC entity other than a primary RLC entity.

8. The apparatus according to claim 6, wherein,
the split secondary RLC entity is an RLC entity other than the primary RLC entity.
